(19) United States
(12) Patent Application Publication
(10) Pub. No.: US 2011/0073818 A1
(43) Pub. Date: Mar. 31, 2011

(54) PULLING TORPEDO HAVING A MATING FEATURE THEREON THAT MATES WITH A MATING FEATURE FORMED ON A CABLE BOOT

(75) Inventor: Laurence R. McColloch, Santa Clara, CA (US)

(73) Assignee: Avago Technologies Fiber IP (Singapore) Pte. Ltd., Singapore (SG)

(21) Appl. No.: 12/569,174

(22) Filed: Sep. 29, 2009

(51) Int. Cl. G02B 6/54; H02G 1/08

(52) U.S. Cl. 254/134.3 R; 385/136

(57) ABSTRACT

A torpedo is provided for use in pulling an optical communications device through ducts, vents, pipes, and the like. The torpedo has at least one mating feature formed thereon that mates with at least one mating feature formed on a boot of an optical fiber cable when the torpedo is attached to the boot. The mating feature formed on the torpedo is typically a key and the mating feature formed on the boot is typically a keyway having a shape that is complementary to the shape of the key. The mating of the key and keyway eliminate the need to use a clamping force to ensure that the grip between the torpedo and the cable will not be lost or compromised when the torpedo is being pulled. The boot of the optical fiber cable may be a standard boot of a standard optical fiber cable, and therefore does not need to be a specialized boot designed specifically for the purpose of attaching to a torpedo. The boot of the optical fiber cable is attached in the normal manner to the strain relief device of the optical fiber cable. Consequently, pulling forces that are exerted by the torpedo on the boot are translated through the boot into the strain relief device of the cable, thereby preventing forces from being exerted on the cable that could possibly damage it.

### TECHNICAL FIELD OF THE INVENTION

The invention relates to a pulling torpedo for pulling an optical communications device through ducts, vents, holes, and other customer installations. More particularly, the invention relates to a pulling torpedo having a mating feature formed thereon that mates with a mating feature formed on a boot of an optical fiber cable having an optical communications device connected thereto.

### BACKGROUND OF THE INVENTION

Optical communications devices, such as optical transmitters, receivers and transceivers, often are connected to an optical fiber cable having one or more optical fibers that are mechanically and optically coupled on ends thereof to a strain relief mechanism of the optical communications device. In order to install an optical communications device at a particular location within a building or other structure, it is often necessary to pull the end of the cable through a duct, vent, hole, or other device. A variety of devices and installation methods have been developed and used for this purpose. When the optical communications device is attached to the cable before the cable is installed (pre-assembly of the optical communications device to the fiber end has a cost advantage), the optical communications device must be protected from the stresses and strains of installing the cable, including those associated with pulling the cable thru ducts, vents and holes.

In order to protect the optical communications device as it is being pulled, it is common to enclose the device inside of an enclosure, sometimes referred to as a torpedo, which is then pulled through the duct, pipe, vent or other opening. A variety of torpedoes have been developed for this purpose. Some known torpedoes clamp directly to the cable or to the boot of the cable. In order to prevent the torpedo from losing its grip on the cable or boot as the torpedo is being pulled, the clamping force must be sufficiently strong to prevent external forces that are exerted on the torpedo from causing its grip to slip. If this clamping force is too great, however, it can damage the cable. Therefore, care must be taken to ensure that the clamping force is sufficiently great, but not too great as to result in damage to the cable.

Some torpedoes have relatively complex designs and large part counts in order to provide a sufficient gripping force on the cable while also preventing the gripping force from causing damage to the cable. For example, the cable may be provided with a special boot and strain relief mechanism such that attachment of the torpedo to the special boot will not damage the cable and the pulling forces will be translated to the strain relief mechanism to ensure that the pulling forces will not cause the grip of the torpedo on the boot to be lost or compromised. A disadvantage of these types of designs is that they are relatively difficult and expensive to manufacture and assemble, which renders them somewhat impractical for use on low cost, high volume optical communication devices.

The strength element, in common optical fiber cables, is made up of the Kevlar® strands under the plastic jacket. Grabbing the jacket of the optical fiber cable indirectly grabs the Kevlar (by crushing the jacket into the Kevlar), but generally the amount of pulling force that can be tolerated does not approach the full strength of the Kevlar (because the jacket slips in the torpedo jaws, or the Kevlar slips in the jacket). Increasing the force of the clamping jaw of the torpedo to the point where the Kevlar cannot slip puts the optical fiber cable at risk of being broken.

A need exists for a torpedo that obviates the need for high clamping forces that may damage the cable, that ensures that pulling forces cannot result in the grip of the torpedo on the cable being lost, that is relatively simple in structure, that is easy to manufacture and assemble, that is relatively inexpensive to manufacture and assemble, and that is suitable for wide scale use.

### SUMMARY OF THE INVENTION

The invention is directed to a torpedo for use in holding an optical communications device as the torpedo is pulled. The torpedo includes an encasement, a pulling eye formed on a forward end of the encasement, and at least a first mating feature formed on a rearward end of the encasement. The encasement has an exterior and an interior. The interior of the encasement defines an area for holding an optical communications device. The pulling eye formed on the forward end of the encasement is configured to receive an attachment device that will be used for pulling the torpedo from one location to another location. The first mating feature formed on the rearward end of the encasement is configured to interlock with a first mating feature formed on an exterior surface of a boot disposed on an end of an optical fiber cable that attaches to the optical communications device. The interlocking of the first mating feature formed on the boot and the first mating feature formed on the rearward end of the encasement locks the torpedo to the boot such that pulling forces exerted on the pulling eye by an attachment device are translated from the first mating feature formed on the rearward end of the encasement to the first mating feature formed on the boot and from the first mating feature formed on the boot to a strain relief device of the optical fiber cable. In this way, the need for gripping devices that exert clamping forces on the cable or boot that can damage the cable is eliminated, thereby allowing the cable to be pulled at the full strength of the strain relief device (e.g., Kevlar) of the optical fiber cable.

The method comprises the following. Providing a torpedo comprising an encasement having an exterior and an interior, and providing an optical communications device located in the interior of the encasement that is connected to an optical fiber cable having a boot and a strain relief device on an end thereof. The encasement has a rearward end that has at least a first mating feature thereon that is in locking engagement with at least a first mating feature formed on the exterior of the boot to lock the boot to the torpedo. The encasement has a forward end with a pulling eye thereon. Pulling forces exerted on the pulling eye are translated from the first mating feature formed on the rearward end of the encasement to the first mating feature formed on the boot and from the first mating feature formed on the boot to the strain relief device of the optical fiber cable.

These and other features and advantages of the invention will become apparent from the following description, drawings and claims.

### BRIEF DESCRIPTION OF THE DRAWINGS

FIG. 1 illustrates a side perspective view of a torpedo in accordance with an illustrative embodiment for housing an optical communications device to be pulled to a location.

FIG. 2A illustrates a perspective side view of the torpedo shown in FIG. 1 with a portion of the encasement removed to reveal an optical communications device positioned within the encasement and some of the features on the inner surfaces of the encasement.

FIG. 2B illustrates an expanded perspective view of a portion of the cross-sectional perspective side view illustrated in FIG. 2A.

FIG. 3 illustrates a side perspective view of a portion of the cross-section of the torpedo encasement half shown in FIG. 2A with the boot pulled back to reveal the strain relief device of the optical fiber cable.

### DETAILED DESCRIPTION OF AN ILLUSTRATIVE EMBODIMENT

In accordance with the invention, a torpedo is provided for use in pulling an optical communications device through ducts and the like. The torpedo has a mating feature formed therein that mates with a mating feature formed on a boot of an optical fiber cable when the torpedo is attached to the boot. The mating feature formed on the torpedo is typically a key and the mating feature formed on the boot is typically a keyway having a shape that is complementary to the shape of the key. The mating of the key and keyway eliminate the need to use a clamping force to ensure that the grip between the torpedo and the cable will not be lost or compromised. The boot of the optical fiber cable may be a standard boot of a standard optical fiber cable, and therefore does not need to be a specialized boot designed specifically for the purpose of attaching to a torpedo. The boot of the optical fiber cable is attached in the normal manner to the strain relief device (e.g., Kevlar) of the optical fiber cable. Consequently, pulling forces that are exerted by the torpedo on the boot are translated through the boot into the strain relief device of the cable, thereby avoiding the exertion of forces on the cable that could possibly damage the cable. It is an easy task to size the keyway to couple force at the load level that the Kevlar is capable of accepting and to allow the strain built into a connector end to couple the force to the Kevlar without placing any crushing load on the fiber.

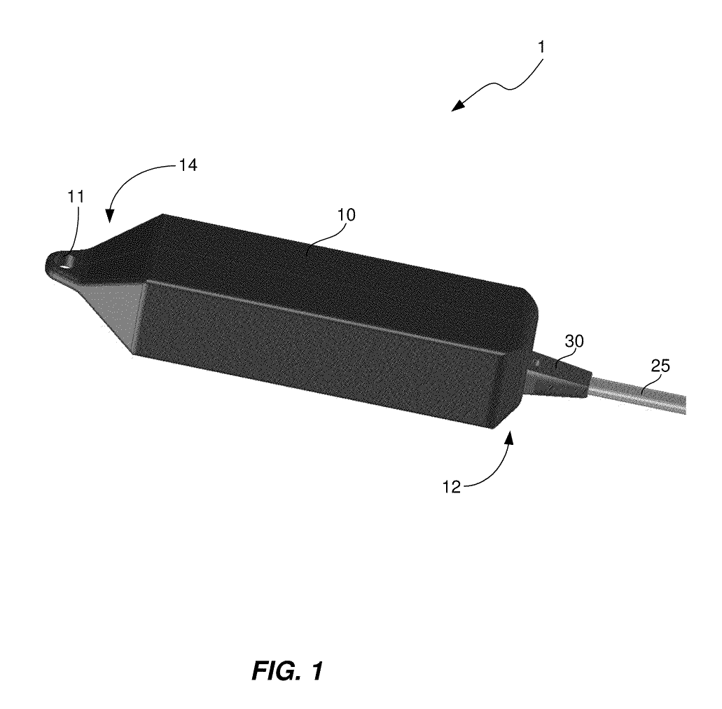

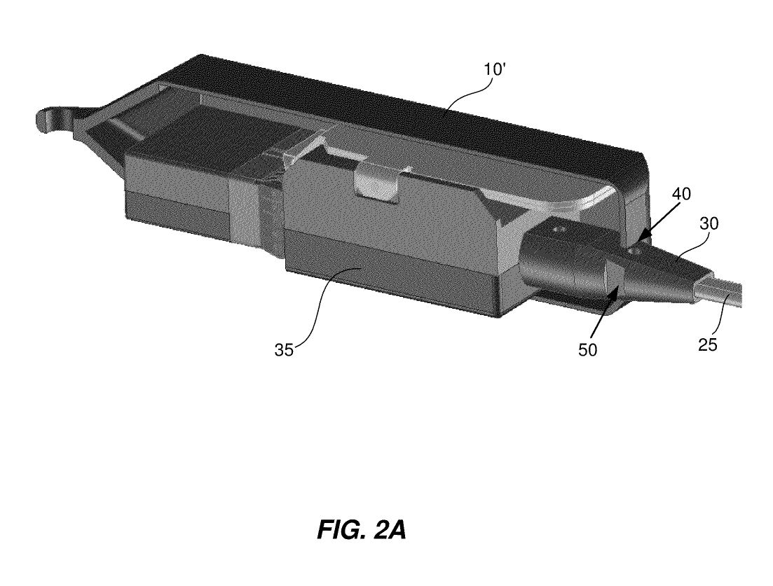

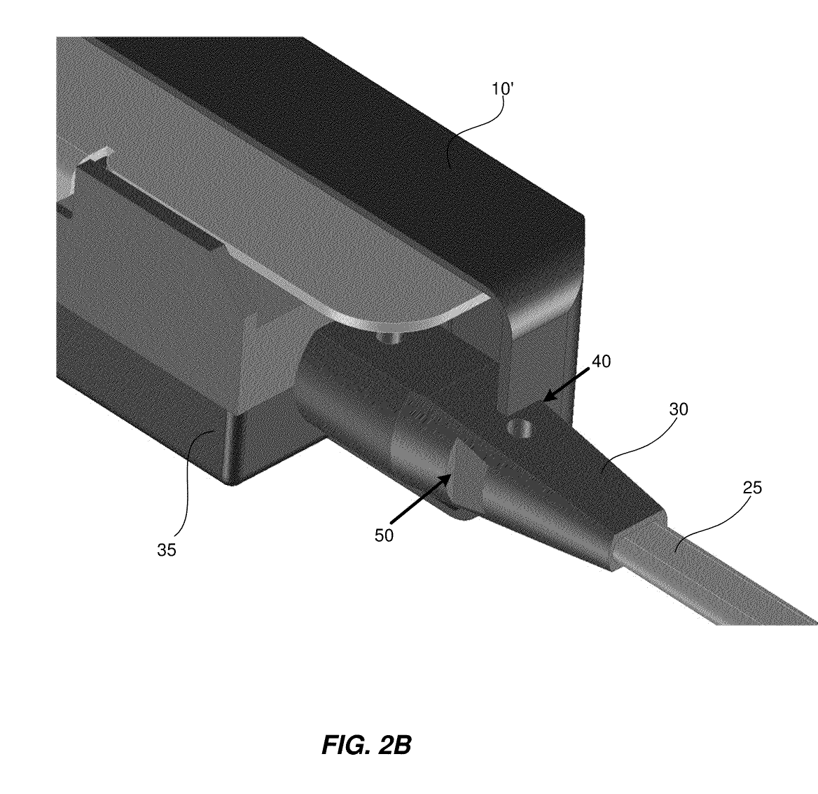

FIG. 1 illustrates a side perspective view of the torpedo 1 in accordance with an illustrative embodiment. The torpedo 1 includes an encasement 10 having a forward end 11 and a rearward end 12. The encasement 10 has space therein for accommodating an optical communications device (not shown). The rearward end 12 of the torpedo 1 attaches to a boot 30 of an optical fiber cable 25. As will be described below in detail with reference to FIGS. 2A and 2B, the rearward end 12 has a key formed therein that is configured to mate with a keyway formed in the boot 30. The forward end 11 of the torpedo 1 has a pulling eye 14 formed therein that is configured to receive an end of an attachment device (not shown), such as, for example, a string, a rope, a hook, etc. Once the attachment device has been attached to the forward end 11 of the torpedo 1 via the pulling eye 14, the attachment device may be used to pull the torpedo through a duct, a vent, a hole, or the like in order to move the optical communications device (not shown) contained within the torpedo 10 to a desired location.

FIG. 2A illustrates a perspective side view of the torpedo 1 shown in FIG. 1 with a portion of the encasement 10 removed to reveal an optical communications device 35 positioned within the encasement 10 and some of the features on the inner surfaces of the encasement 10. The optical communications device 35 shown in FIG. 2A is a particular type of parallel optical communications device known in the industry as a cSFP optical transceiver. The invention, however, is not limited with respect to the type of optical communications device with which the torpedo 1 can be used. For example, the torpedo 1 is suitable for use with various types of small form factor pluggable (SFP) and SFP+ transmitters, receivers and transceivers. Also, although the torpedo 1 is shown as having a particular shape and configuration, the invention is not limited to the torpedo 1 having any particular shape or configuration.

The rearward end 12 of the torpedo encasement 10 has a key 40 formed therein that is shaped and sized to mate with a keyway 50 formed in the boot 30. In the embodiment shown in FIG. 2A, the encasement 10 has two identical halfs, although only one of the halfs 10′ is shown in FIG. 2A. The halfs 10′ are coupled together by a coupling mechanism, such as a snap mechanism, epoxy, etc. Each of the halfs contains one of the keys 40 and each side of the boot 30 has a keyway 50 formed therein. The keyways 50 are disposed on opposite sides of the boot 30 and positioned such that the keyways 50 receive the respective keys 40 when the two halfs 10′ of the encasement 10 are coupled together. In accordance with this illustrative embodiment, the load is depicted as being symmetrical, which is generally a better design. It should be noted, however, that the invention is not limited to symmetrical designs.

FIG. 2B illustrates an expanded perspective view of a portion of the cross-sectional perspective side view illustrated in FIG. 2A. In the expended view shown in FIG. 2B, the mating of the key 40 and keyway 50 can be more clearly seen. The keyways 40 formed in opposite sides of the boot 30 are respective slots formed by removing a small portion of the boot 30. The slots that form the keyways 50 may be formed during the process of molding the boot 30 by simply making a minor variation to the shape of the mold tool that is used to make the boot 30. Thus, boots 30 having the keyways 50 formed therein may be easily and inexpensively produced in mass quantity without making any major changes to the boot manufacturing process and without making any changes to the process of attaching the boot 30 to the cable 25.

Use of the keys 40 and keyways 50 obviates the need to provide a clamping force to create a grip that is sufficient to withstand the pulling forces that will be exerted on the torpedo 1. The mating of the respective keys 40 with the respective keyways 50 locks the torpedo encasement 10 to the boot 30. This mating arrangement, however, does not exert any clamping force on the boot, and therefore eliminates the possibility that the coupling of the torpedo 1 with the boot 30 may somehow result in the cable 25 being damaged. Consequently, the only forces that will be exerted on the boot 30 are the pulling forces that are exerted on the pulling eye 14 (FIG. 1) formed on the forward end 11 of the encasement 10. Because the torpedo 1 does not need to be configured to exert a clamping force on the boot 30, there is more flexibility with respect to the types of materials that may be used to form the torpedo 1. For example, the torpedo encasement 10 may be formed of plastic and may be formed as a single integral piece or, as described above with respect to the example shown in FIGS. 2A and 2B, or as multiple pieces that are configured to be connected together. For this reason, the torpedo 1 can be made very easily and inexpensively. In addition, these features allow the torpedo 1 to be manufactured on a very large scale in a very cost-efficient manner.

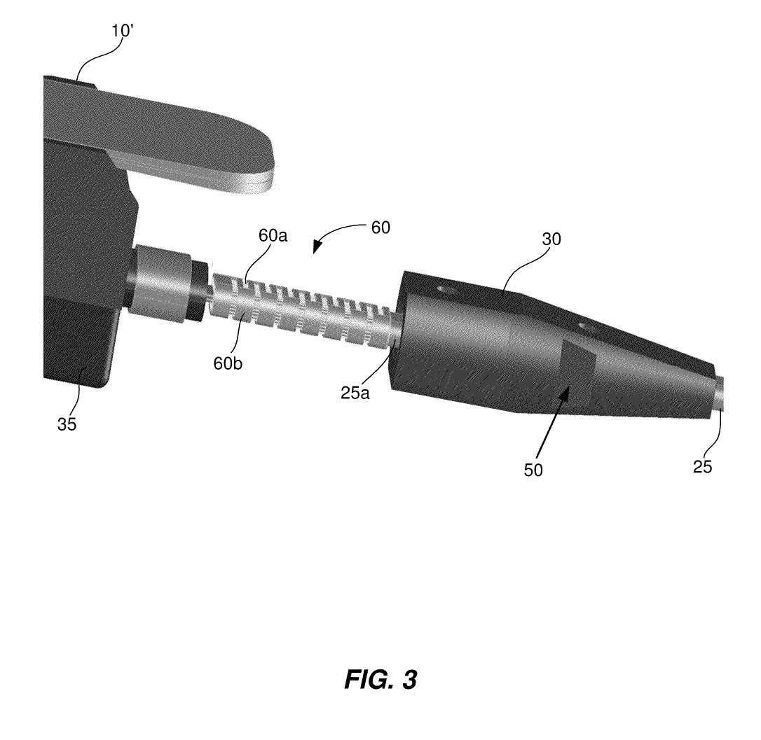

FIG. 3 illustrates a side perspective view of a portion of the cross-section of the torpedo encasement half 10′ shown in FIG. 2A with the boot 30 pulled back to reveal the strain relief device 60 of the optical fiber cable 25. The strain relief device 60 is typically made up of strength members 60a, which are typically Kevlar fiber strands, and a metal crimp 60b. The strength members 60a are part of the optical fiber cable 25 and pass through the entire length of the optical fiber cable 25. The ends of the strength members 60a are pulled out of the end of the cable 25 and crimped to the outer surface of the jacket 25a of the cable 25 by the metal crimp 60b. The metal crimp 60b is bonded to the strength members 60a and to the jacket 25a of the cable 25. In accordance with an illustrative embodiment, the crimp 60b is segmented to provide a larger bonding area as well as additional flexibility. The inside of the boot 30 is fixedly secured to the strain relief device 60 in the typical manner.

With the configuration of the torpedo 1 described above with reference to FIGS. 1-3, no clamping forces are exerted on the boot 30 because the key/keyway configuration 40/50 (FIG. 2A) relies on interlocking engagement rather than clamping engagement to couple the torpedo 1 to the boot 30. Therefore, only pulling forces that are exerted on the torpedo 1 are translated to the boot 30 via the key/keyway configuration 40/50. The pulling forces that are translated to the boot 30 are then translated through the boot 30 to the strain relief device 60, which absorbs the pulling force. It should be noted that none of the pulling force is exerted on the optical communications device 35 located within the torpedo 1, and thus there is no risk of damage to the optical communications device. Likewise, none of the pulling force is exerted on the optical fiber or fibers (not shown) of the cable 25, and thus there is no risk of damage to the optical fiber or fibers of the cable 25.

It should be noted that the invention has been described with respect to illustrative embodiments for the purpose of describing the principles and concepts of the invention. The invention is not limited to these embodiments. For example, while the invention has been described with reference to using a particular configuration for the torpedo 1, the invention is not limited to this particular configuration. In addition, while the embodiments described herein provide the keys 40 and keyways 50 are formed in the encasement 10 and in the boot 30, respective, the keys 40 and keyways 50 could instead be formed in the boot 30 and in the encasement 10, respectively. Also, the invention is not limited with respect to the shapes of the keyways and keys, or whether multiple or a single key and keyway are used for this purpose. As will be understood by those skilled in the art in view of the description being provided herein, modifications may be made to the embodiments described to provide a torpedo that achieves the goals of the invention, and all such modifications are within the scope of the invention.

What is claimed is:

1. A torpedo for use in holding an optical communications device as the torpedo is pulled, the torpedo comprising:
an encasement having an exterior and an interior, the interior of the encasement defining an area for holding an optical communications device, the exterior having a forward end and a rearward end;
a pulling eye formed on the forward end of the encasement, the pulling eye being configured to receive an attachment device that will be used for pulling the torpedo from one location to another location;
at least a first mating feature formed on the rearward end of the encasement, the first mating feature being configured to interlock with a first mating feature formed on an exterior surface of a boot disposed on an end of an optical fiber cable that attaches to the optical communications device, wherein the interlocking of the first mating features formed on the boot and on the rearward end of the encasement locks the torpedo to the boot such that pulling forces exerted on the pulling eye by an attachment device connected to the pulling eye are translated from the first mating feature formed on the rearward end of the encasement to the first mating feature formed on the boot and from the first mating feature formed on the boot to a strain relief device of the optical fiber cable.

2. The torpedo of claim 1, wherein the first mating feature formed on the rearward end of the encasement is a first key and wherein the first mating feature formed on the exterior of the boot is a first keyway, wherein the first key and the first keyway have complementary shapes and sizes such that the first key lockingly engages the first keyway to lock the torpedo to the boot.

3. The torpedo of claim 1, wherein said at least a first mating feature formed on the rearward end of the encasement comprises at least first and second keys formed on the rearward end of the encasement, and wherein said at least a first mating feature formed on the exterior of the boot comprises at least first and second keyways formed on opposite sides of the exterior of the boot, wherein the first and second keys and the first and second keyways, respectively, have complementary shapes and sizes such that the first and second keys lockingly engage the first and second keyways, respectively, to lock the torpedo to the boot.

4. The torpedo of claim 1, wherein the first mating feature formed on the rearward end of the encasement is a first keyway and wherein the first mating feature formed on the exterior of the boot is a first key, wherein the first key and the first keyway have complementary shapes and sizes such that the first key lockingly engages the first keyway to lock the torpedo to the boot.

5. The torpedo of claim 4, wherein said at least a first mating feature formed on the rearward end of the encasement comprises at least first and second keyways formed on the rearward end of the encasement, and wherein said at least a first mating feature formed on the exterior wall of the boot comprises at least first and second keys formed on opposite sides of the exterior of the boot, wherein the first and second keys and the first and second keyways, respectively, have complementary shapes and sizes such that the first and second keys lockingly engage the first and second keyways, respectively, to lock the torpedo to the boot.

6. The torpedo of claim 1, wherein the torpedo is made of a single piece of plastic material.

7. The torpedo of claim 1, wherein the encasement comprises at least two encasement portions that are made of plastic material that interconnect to form the encasement, and wherein said at least one mating feature formed on the rearward end of the encasement includes at least first and second mating features formed on the first and second encasement portions, and wherein said at least one mating feature formed on the exterior of the boot includes at least first and second mating features formed on opposite sides of the exterior of the boot, and wherein when the first and second encasement portions are interconnected to form the encasement, the first and second mating features formed on the first and second encasement portions oppose each other and lockingly engage the first and second mating features, respectively, formed on opposite sides of the exterior of the boot.

8. A method of using a torpedo to pull an optical communications device from one location to another location, the method comprising:
providing a torpedo comprising:
an encasement having an exterior and an interior, the interior of the encasement defining an area for holding an optical communications device, the exterior having a forward end and a rearward end;
a pulling eye formed on the forward end of the encasement, the pulling eye being configured to receive an attachment device for use in pulling the torpedo from one location to another location; and
at least a first mating feature formed on the rearward end of the encasement;
and
providing an optical communications device that is attached to a first end of an optical fiber cable, the first end of the optical fiber cable being at least partially surrounded by a boot, the boot having at least a first mating feature formed on an exterior thereof, the optical communications device being located within the interior of the encasement, the first mating feature formed on the rearward end of the encasement being in locking engagement with the first mating feature formed on the exterior surface of the boot, wherein the locking engagement of the first mating feature formed on the boot with the first mating feature formed on the rearward end of the encasement locks the torpedo to the boot such that pulling forces exerted on the pulling eye are translated from the first mating feature formed on the rearward end of the encasement to the first mating feature formed on the boot and from the first mating feature formed on the boot to a strain relief device of the optical fiber cable.

9. The method of claim 8, wherein the first mating feature formed on the rearward end of the encasement is a first key and wherein the first mating feature formed on the exterior of the boot is a first keyway, wherein the first key and the first keyway have complementary shapes and sizes such that the first key lockingly engages the first keyway to lock the torpedo to the boot.

10. The method of claim 8, wherein said at least a first mating feature formed on the rearward end of the encasement comprises at least first and second keys formed on the rearward end of the encasement, and wherein said at least a first mating feature formed on the exterior of the boot comprises at least first and second keyways formed on opposite sides of the exterior of the boot, wherein the first and second keys and the first and second keyways, respectively, have complementary shapes and sizes such that the first and second keys lockingly engage the first and second keyways, respectively, to lock the torpedo to the boot.

11. The method of claim 8, wherein the first mating feature formed on the rearward end of the encasement is a first keyway and wherein the first mating feature formed on the exterior of the boot is a first key, wherein the first key and the first keyway have complementary shapes and sizes such that the first key lockingly engages the first keyway to lock the torpedo to the boot.

12. The method of claim 8, wherein said at least a first mating feature formed on the rearward end of the encasement comprises at least first and second keyways formed on the rearward end of the encasement, and wherein said at least a first mating feature formed on the exterior wall of the boot comprises at least first and second keys formed on opposite sides of the exterior of the boot, wherein the first and second keys and the first and second keyways, respectively, have complementary shapes and sizes such that the first and second keys lockingly engage the first and second keyways, respectively, to lock the torpedo to the boot.

13. The method of claim 8, wherein the torpedo is made of a single piece of plastic material.

14. The method of claim 8, wherein the encasement comprises at least two encasement portions that are made of plastic material that interconnect to form the encasement, and wherein said at least one mating feature formed on the rearward end of the encasement includes at least first and second mating features formed on the first and second encasement portions, and wherein said at least one mating feature formed on the exterior of the boot includes at least first and second mating features formed on opposite sides of the exterior of the boot, and wherein when the first and second encasement portions are interconnected to form the encasement, the first and second mating features formed on the first and second encasement portions oppose each other and lockingly engage the first and second mating features, respectively, formed on opposite sides of the exterior of the boot.

15. The method of claim 8, wherein the strain relief device includes on or more strength members and a crimp device, the strength members passing through at least a portion of the optical fiber cable and having ends that pass out of the first end of the optical fiber cable, the ends that pass out of the first end of the optical fiber cable being crimped by the crimp device to a jacket of the optical fiber cable, and wherein an inner surface of the boot is bonded to portions of the crimp device and to portions of the strength members.

16. The method of claim 15, wherein the strength members comprise Kevlar®.
